(19) United States
(12) Patent Application Publication
(10) Pub. No.: US 2025/0113332 A1
(43) Pub. Date: Apr. 3, 2025

(54) Multilevel Wireless Communication Device Detection

(71) Applicant: Apple Inc., Cupertino, CA (US)

(72) Inventors: Vignesh Babu MOORTHY, San Jose, CA (US); Benjamin A WERNER, San Jose, CA (US); Sanjeevi BALASUBRAMAMIAN, San Jose, CA (US)

(21) Appl. No.: 18/883,599

(22) Filed: Sep. 12, 2024

Related U.S. Application Data
(60) Provisional application No. 63/586,688, filed on Sep. 29, 2023.

(51) Int. Cl. H04W 64/00; G01S 17/04; H04B 1/7163; H04W 84/12

(52) U.S. Cl. CPC H04W 64/006; G01S 17/04; H04B 1/7163; H04W 84/12

(57) ABSTRACT

An apparatus configured to generate, for transmission to a wireless communication device, a request to initiate a ranging operation, process a response indicating that the apparatus is to locate the wireless communication device, generate first ranging data, process second ranging data, determine a direction of the wireless communication device relative to the apparatus based on at least the first ranging data and the second ranging data, wherein the direction is based on a spherical coordinate system including a radial distance, an azimuthal angle, and a polar angle and generate, for display on a display device, a graphic based on at least the determined direction of the wireless communication device relative to the apparatus, the graphic indicating a three dimensional direction of the wireless communication device relative to the apparatus.

### PRIORITY/INCORPORATION BY REFERENCE

This application claims priority to U.S. Provisional Application Ser. No. 63/586,688 filed on Sep. 29, 2023, entitled “Multilevel Wireless Communication Device Detection and Finding,” the entirety of which is incorporated by reference herein.

### BACKGROUND

There are various mechanisms that allow wireless communication devices to locate one another. Some mechanisms use these features to dynamically generate directions that enable a user of one device to locate another device. For example, a first wireless communication device may receive information from a second wireless communication device that is used to determine the direction of the second wireless communication device relative to the first wireless communication device. The first wireless communication device may then output directions that enable its user to navigate to the second wireless communication device.

Certain multi-level/multi-floor environments have proven challenging for existing finding implementations. These scenarios include but are not limited to, malls, stadiums, and transit stations. For example, a first user may be located on the first floor of a building and a second user may be located on the second floor of the building. The users may wish to find one another using the finding software on their wireless communication devices, but these devices typically struggle handling Z-dimensional navigation. Improvements to these 3-D navigation scenarios are thus needed.

### SUMMARY

Some example embodiments are related to an apparatus having processing circuitry configured to generate, for transmission to a wireless communication device, a request to initiate a ranging operation, process, based on one or more signals received from the wireless communication device, a response indicating that the apparatus is to locate the wireless communication device, generate, for transmission to a wireless communication device, first ranging data, process, based on one or more signals received from the wireless communication device, second ranging data, determine a direction of the wireless communication device relative to the apparatus based on at least the first ranging data and the second ranging data, wherein the direction is based on a spherical coordinate system including a radial distance, an azimuthal angle, and a polar angle and generate, for display on a display device, a graphic based on at least the determined direction of the wireless communication device relative to the apparatus, the graphic indicating a three dimensional direction of the wireless communication device relative to the apparatus.

Other example embodiments are related to a method performed by an apparatus, the method including generating, for transmission to a wireless communication device, a request to initiate a ranging operation, processing, based on one or more signals received from the wireless communication device, a response indicating that the apparatus is to locate the wireless communication device, generating, for transmission to a wireless communication device, first ranging data, processing, based on one or more signals received from the wireless communication device, second ranging data, determining a direction of the wireless communication device relative to the apparatus based on at least the first ranging data and the second ranging data, wherein the direction is based on a spherical coordinate system including a radial distance, an azimuthal angle, and a polar angle and generating, for display on a display device, a graphic based on at least the determined direction of the wireless communication device relative to the apparatus, the graphic indicating a three dimensional direction of the wireless communication device relative to the apparatus.

### BRIEF DESCRIPTION OF THE DRAWINGS

FIG. 1 shows an example arrangement according to various example embodiments.

FIG. 2 shows an example wireless communication device according to various example embodiments.

FIG. 3 shows a method for performing a find location operation between the first wireless communication device and the second wireless communication device according to various example embodiments.

FIG. 4 shows an example architecture for a finder and findee according to various example embodiments.

FIG. 5 shows example display devices showing navigational arrows, according to various example embodiments.

### DETAILED DESCRIPTION

The example embodiments may be further understood with reference to the following description and the related appended drawings, wherein like elements are provided with the same reference numerals. The example embodiments relate to mechanisms that enable a user of one wireless communication device to locate another wireless communication device and/or user in three dimensional space.

The example embodiments are described with regard to wireless communication devices. As will be described in greater detail below, the wireless communication devices may include any electronic component configured with the hardware, software, and/or firmware to establish a short-range wireless connection to another wireless communication device.

Some example embodiments include the use of short-range communication connections. In some examples, a short-range communication connection may be a Bluetooth connection, e.g., Bluetooth Classic, Bluetooth Low-Energy (BLE), etc. This is only an example and the principles described herein for the example embodiments may be applied to other types of short-range communication connections.

Some example embodiments include the use of ultra-wideband (UWB) communication connections. Other example embodiments include the use of cellular network connections or another wireless network connection such as a wireless local area network (WLAN) or a wide area network (WAN).

The example embodiments are also described with reference to a finder and a findee. In this context, the “findee” may generally refer to the wireless communication device and/or user thereof that is sharing their location with others. The “finder” may generally refer to the wireless communication device and/or user thereof that receives location information from another user. To provide a non-limiting example, a finder may receive information from the findee that is used to determine the direction of the findee relative to the finder. The finder may dynamically output directions that enable its user to navigate to the findee.

As described above, people/wireless communications device finding in multi-level environments remains an ongoing challenge in the field. Finding applications typically struggle identifying and conveying to a user that the target/findee has a different z-coordinate than the user.

The example embodiments are described with respect to a variety of sensor and software implementations to address the aforementioned multi-level finding scenarios.

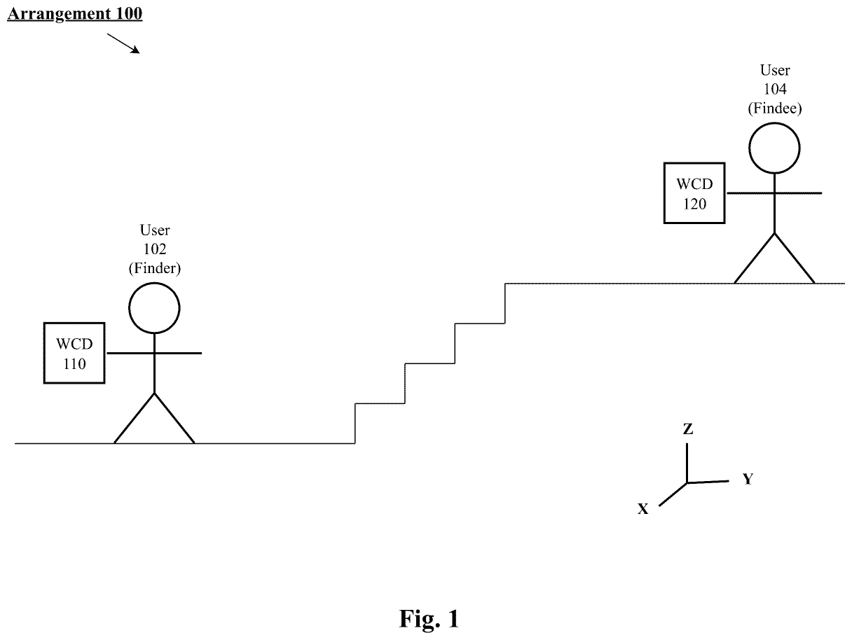

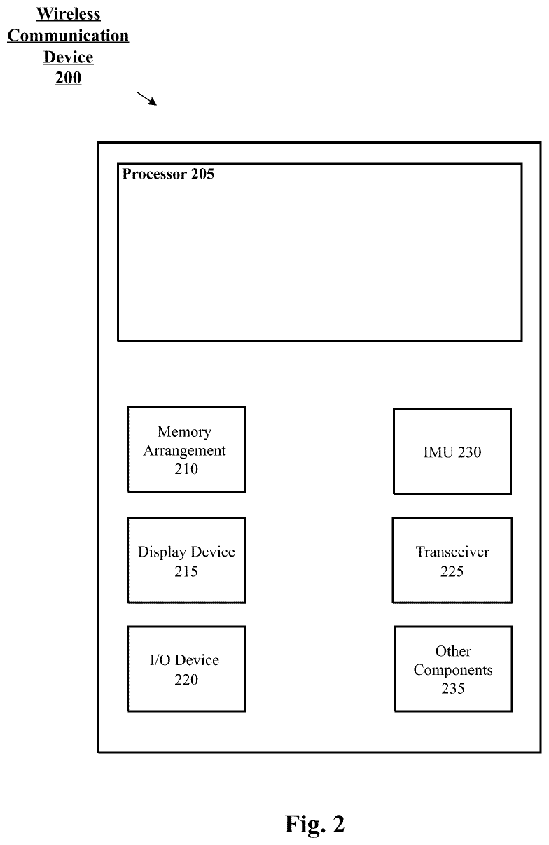

FIG. 1 shows an example arrangement 100 according to various example embodiments. The example arrangement 100 includes a first wireless communication device 110 and a second wireless communication device 120. Examples of these wireless communication devices 110 and 120 will be described in greater detail below with regard to FIG. 2. In the example of FIG. 1, the first wireless communication device 110 and the second wireless communication device 120 may not currently have a direct connection to one another.

In this example, a user 102 of the first wireless communication device 110 may wish to locate a user 104 of the second wireless communication device 120. The users 102 and 104 may be separated in the Z-dimension, such that location and navigation between one another will require the wireless communication devices 110 and 120 to analyze and interpret the 3D space of the arrangement 100. As will be described in greater detail below, the users 102 and 104 of the first and second wireless communication devices 110 and 120 may form or have previously formed a relationship that allows the first and second wireless communication devices 110 and 120 to find each other. In the example of the user 102 of the first wireless communication device 110 wishing to locate the user 104 of the second wireless communication device 120, the second wireless communication device 120 and/or user 104 thereof may be considered to be the “findee,” (e.g., sharing their location with others) and the first wireless communication device 110 and/or user 102 thereof may be considered to be the “finder,” e.g., receiving location information from another user. One of skill in the art will appreciate that certain applications and services allow users to share their locations with one another for various lengths of time, from temporary (e.g., on the order of minutes to hours) to indefinitely.

In non-limiting examples, the finder 102 may move towards the findee 104 (dynamic/static case); in other scenarios the finder 102 and the findee 104 may both be moving (dual dynamic). One of skill in the art will appreciate that numerous combinations of wireless communication devices 110 and 120 may be used in the example finding scenarios (phone/phone watch/phone, phone/tablet, phone/headset, etc.).

FIG. 2 shows an example wireless communication device 200 according to various example embodiments. The wireless communication device 200 of FIG. 2 may represent the wireless communication device 110 or 120 described with regard to FIG. 1. The wireless communication device 200 may be any type of electronic component that is configured to wirelessly connect to another wireless communication device. A wireless connection may be a short-range communication connection. Non-limiting examples include mobile phones, smartphones, tablet computers, wearables, embedded devices, Internet of Things (IoT) devices, virtual reality headsets, augmented reality headsets, etc.

The wireless communication device 200 may include a processor 205, a memory arrangement 210, a display device 215, an input/output (I/O) device 220, a transceiver 225, an IMU 230 and other components 235. The other components 235 may include, for example, an audio input device, an audio output device, a data acquisition device, cameras, visual inertial odometry (VIO) components, light detection and ranging (LiDAR) sensors, barometric pressure sensor (i.e., barometer), ports to electrically connect to other electronic devices, sensors to detect conditions of the device, etc.

The processor 205 may be configured to execute a plurality of engines for the wireless communication device 200. For example, the engines may perform operations related to locating another wireless communication device such as, but not limited to, determining if another wireless communication device is allowed to find the wireless communication device 200 based on an advertisement received from other wireless communication devices, forming responses to another wireless communication device attempting to find the wireless communication device 200 and generating directions that enable the user of the wireless communication device 200 to locate another device. Examples of these operations will be described in greater detail below.

The above referenced engines being an application (e.g., a program) executed by the processor 205 is only an example. The functionality associated with the engines may also be represented as a separate incorporated component of the wireless communication device 200 or may be a modular component coupled to the wireless communication device 200, e.g., an integrated circuit with or without firmware. For example, the integrated circuit may include input circuitry to receive signals and processing circuitry to process the signals and other information. The engines may also be embodied as one application or separate applications. In addition, in some wireless communication devices, the functionality described for the processor 205 is split among two or more processors such as a baseband processor and an applications processor. The example embodiments may be implemented in any of these or other configurations of a wireless communication device.

The memory arrangement 210 may be a hardware component configured to store data related to operations performed by the wireless communication device 200. The display device 215 may be a hardware component configured to show data to a user, e.g., display user interfaces (UIs), directional arrows, text messages, etc. The I/O device 220 may be a hardware component that enables the user to enter inputs (e.g., to locate another person, to allow finding location services to be used, etc.). The display device 215 and the I/O device 220 may be separate components or integrated together such as a touchscreen or integrated into a virtual reality headset or an augmented reality headset.

The transceiver 225 may be a hardware component configured to establish a wireless connection with one or more networks or with one or more other wireless communication devices. The transceiver 225 may be configured to use more than one radio access technology. Accordingly, the transceiver 225 may operate on a variety of different frequencies or channels (e.g., set of consecutive frequencies) to communicate with the networks and/or other wireless communication devices. The transceiver 225 may also be configured to use a short-range communication protocol, e.g., Bluetooth. The transceiver 225 may include separate transceiver circuitry for each of a respective type of wireless connection, radio access technology, and/or range of frequencies of operation. The transceiver 225 may comprise transceiver circuitry configured for operating using Bluetooth communication. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals for implementing any one of the methods described herein.

The IMU 230 may be a hardware component comprising one or more sensors. The sensors may include, but are not limited to, one or more gyroscopes and one or more accelerometers. The IMU 230 may collect data such as, but not limited to, acceleration measurements for the wireless communication device 200 and angular velocity measurements of the wireless communication device 200. When the wireless communication device 200 is a findee, the IMU data collected by the IMU 235 may be signaled to the finder where it is used to generate directions that enable the finder to locate the wireless communication device 200. When the wireless communication device 200 is a finder, the IMU data collected by the IMU 235 may be used to generate directions that enable the user of the wireless communication device 200 to locate the findee.

According to some aspects, the example embodiments relate to generating directions that enable the user of the finder to locate the findee. The example embodiments are described within the context of a find operation initiated by the finder. An example find operation is described below with regard to the methods 300. However, the methods 300 are not intended to limit the example embodiments in any way and is merely provided as a general overview of an example find operation. The example embodiments may be used independently from one another, in conjunction with currently implemented people finder or device finder mechanisms, in conjunction with future implementations of people finder or device finder mechanisms or independently from other people finder or device finder mechanisms.

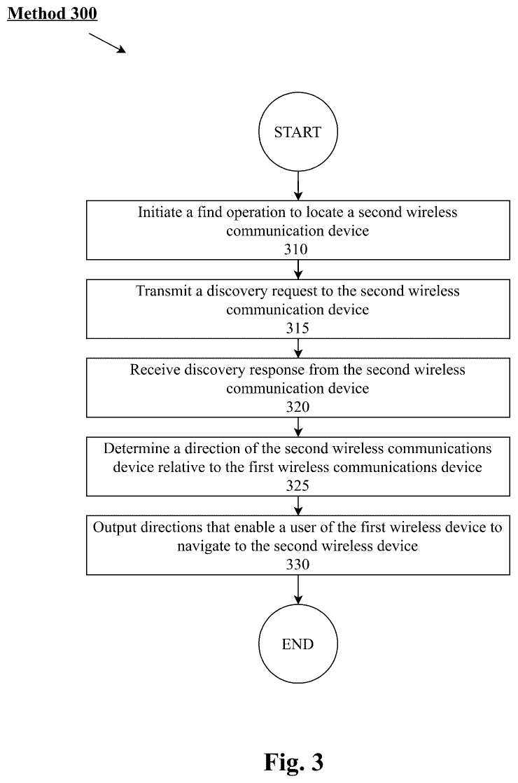

FIG. 3 shows a method 300 for performing a find location operation between the first wireless communication device 110 and the second wireless communication device 120 according to various example embodiments. In this example, the first wireless communication device 110 may be the finder and the second wireless communication device 120 may be the findee.

In 310, the first wireless communication device 110 initiates a find operation to locate the second wireless communication device 120. As will be described in greater detail below, the find operation may be used by the first wireless communication device 110 to generate directions that enable the user of the first wireless communication device 110 to navigate to the second wireless communication device 120. The directions may consist of displaying an arrow graphic on the user interface (UI) of an application running on the first wireless communication device 110 that points in the direction of the second wireless communication device 120. The arrow may automatically update its orientation based on the location of the first wireless communication device 110 relative to the second wireless communication device 120.

Prior to the first wireless communication device 110 initiating the find operation for the second wireless communication device 120, the devices 110-120 and/or the users 102 and 104 thereof may have communicated their intentions to form a friendship relationship. Throughout this description, a friendship relationship refers to a configuration where one wireless communication device is permitted to find another wireless communication device using the find operation. For example, the first wireless communication device 110 may be permitted to locate the second wireless communication device 120 and/or the second wireless communication device 120 may be permitted to locate the first wireless communication device 110.

The friendship relationship between the first wireless communication device 110 and the second wireless communication device 120 may encompass a state of i) only the first wireless communication device 110 is permitted to operate as a finder and only the second wireless communication device 110 is permitted to operate as a findee, ii) only the second wireless communication device 120 is permitted to operate as a finder and only the first wireless communication device 110 is permitted to operate as a findee or iii) there is a reciprocal relationship where both the first wireless communication device 110 and the second wireless communication device 120 are permitted to operate as a finer and findee. However, reference to the term “friendship relationship” is merely provided for illustrative purposes. Different entities may refer to this concept by a different name. Additionally, the various friendship relationships may be limited in time (for example, until the end of the day) or indefinite.

To provide a general non-limiting example, the users of the wireless communication devices may have a find location application and the users may enter their intention to form a friendship via a user interface (UI) of the application. The wireless communication device 120 may send one or more keys to the first wireless communication device 110 that are used to establish direct communication between the devices during a find operation. The one or more keys may be exchanged between the first communication device 110 and the second communication device 120 directly using short-range communication or indirectly using a network connection (for example, via cellular or Wi-Fi).

In some embodiments, a key associated with the friendship relationship may be a one-to-one key, e.g., the key is unique to the finder/findee friendship and only the friendship pair will know this friendship key and no other device may resolve the finder or findee using the specific friendship key. The users sharing their location may revoke that permission at any time, either offline (e.g., by disabling a specific friendship key) or online (e.g., by indicating to the finder that the friendship key is no longer active). However, reference to a key mechanism is merely provided for illustrative purposes. The example embodiments may utilize any appropriate type of mechanism to manage the permissions with regard to the finder and findee relationship between two or more devices.

In 315, the first wireless communication device 110 transmits to the second wireless communication device 120, one or more signals including a request to initiate a ranging operation. The request may include data related to finding the second wireless communication device 120. For example, the request may include data that is encrypted using a key known to the finder and findee. In some examples, the request may be a Bluetooth advertisement.

After transmitting the request, the first wireless communication device 110 may receive one or more signals from the second wireless communication device 120 that comprises a response indicating that the first wireless communication device 110 is to locate the second wireless communication device 120. The first wireless communication device 110 (e.g., processor) may decode a request based on one or more signals transmitted by the second wireless communication device 120 over a cellular or WiFi network.

In some examples, after transmitting a Bluetooth advertisement comprising the request, the first wireless communication device 110 may perform scanning operations to determine if the second wireless communication device 120 has responded to the Bluetooth advertisements. Like the advertisement operation, the operations may be performed continuously until the findee is located or the user of the finder discontinues attempting to locate the findee.

Prior to 310 or 315, on the findee side, the second wireless communication device 120 may scan for Bluetooth advertisements from other wireless communication devices that are attempting to find the second wireless communication device 120. The scanning operation may be any scanning operation supported by the Bluetooth protocol being executed by the findee. The findee may be triggered to perform the scanning operations for any of a variety of different reasons (e.g., in accordance with a schedule, triggered by a predetermined condition, in response to user input, etc.). In addition, the scanning operations may be performed when the findee is offline, e.g., has no connection to a wireless network. The scanning operation may be continuous until the user of the findee turns off this capability or until the findee has identified a finder (e.g., first communication device 110). These scanning examples are only provided for illustrative purposes and any appropriate type of scanning operation may be used.

In 320, the first wireless communication device 110 receives a Bluetooth advertisement from the second wireless communication device 120. In this example, it may be assumed that the second wireless communication device 120 received a Bluetooth advertisement transmitted by the first wireless communication device 110 in 315. The second wireless communication device 120 may determine, based on the advertisement and the state of their friendship relationship, that the first wireless communication device 110 is permitted to locate the second wireless communication device 120 using the find operation. The second wireless communication device 120 may then transmit one or more Bluetooth advertisements to the first wireless communication device 110 where at least Bluetooth advertisement is received in 320. Therefore, the Bluetooth advertisement in 320 may indicate that the second wireless communication device 120 received a Bluetooth advertisement from the first wireless communication device 110 for the find operation.

The exchange of signals in 315-320 allows the finder and the findee to discover one another's presence and confirm the state of their friendship relationship. After this exchange, a more precise location operation may be performed. For example, an ultra-wideband (UWB) ranging operation may be used to determine a more precise location of the findee.

In 325, the first wireless communication device 110 determines a direction of the second wireless communication device 120 relative to the first wireless communication device 110. For example, as mentioned above, the first wireless communication device 110 may perform a UWB ranging operation to determine the direction of the second wireless communication device 120. Alternatively, or in addition to the UWB ranging operation, the first wireless communication device 110 may use other information collected by other components of the first wireless communication device 110 or the second wireless communication device 120 to determine the direction of the second wireless communication device 120. In some examples, this information may include IMU data collected by the first wireless communication device 110 and/or IMU data collected by the second wireless communication device 120 and provided to the first wireless communication device 110 in any appropriate manner.

In some example embodiments, the first wireless communication device 110 and the second wireless communication device 120 may each utilize a barometer to determine barometric pressure values. These barometric pressure values may be used to determine an altitude of each of the wireless communications devices. These altitude and/or pressure values may correspond with various elevations (e.g., floors) of a navigational environment. In some example embodiments, the first wireless communication device 110 and the second wireless communication device 120 may first determine an initial distance and direction/orientation from one another. This initial distance may be augmented by the barometer values from each of the first wireless communication device 110 and the second wireless communication device 120. The distance, direction, and barometer values may be updated over various intervals based on operator implementation.

In other example embodiments, light detection and ranging (LiDAR) may be used to enhance the spatial awareness of the finder and/or the findee wireless communication devices. LiDAR may be used to generate a spatial depth map of the surroundings of the wireless communications device. In a non-limiting example, the first wireless communication device 110 may utilize LiDAR to augment the directions provided to the user 102. The LiDAR depth map may, for example, be used to adjust the user interface (for example, a displayed navigational arrow) based on obstacles on the navigational path, instead of directing the user 102 through the obstacles. LiDAR may also enhance wall/floor/level detection.

The example embodiments may utilize a 3D spherical coordinate system instead of a 2D cartesian coordinate system. The finder and/or findee wireless communication devices may utilize radial distance, azimuthal angle, and polar angle. In some example embodiments, UWB and/or LiDAR data may be used to generate precise 3D coordinates, significantly improving 3D-navigation.

In some example embodiments, the wireless communication devices 110 and 120 may feature 3D multi-floor detection. A user interface may inform users that their target (e.g., the findee) may be located on a different floor. In some example embodiments, the findee may receive a notification that the finder is attempting to locate the findee. In a non-limiting example, a findee user 104 may receive instructions from the user interface of the wireless communication device 120 to not move, because the finder user 102 is attempting to locate them. This may be valuable for a parent seeking a lost child in a crowded multi-level environment.

In some example embodiments, the wireless communications device 110 may use synthetic aperture techniques to derive location information for the user 110 and/or user 104. The synthetic aperture may be used to show the user a navigational indicator, such as an arrow towards a findee.

In some example embodiments, Wi-Fi access point names (APNs) may be used for triangular provisioning of the Z-axis of the wireless communication device. For example, in a building with multiple floors, each floor may utilize a different APN associated with that floor. The finder wireless communication device 110 may determine one or more APNs associated with its current floor, the findee wireless communication device 120 may report one or more APNs associated with its current floor.

In some example embodiments, the wireless communication device 110 and/or wireless communication device 104 may exchange acoustic data that may or may not be audible to the users 102 and 104. For example, once the user 102 is on the same floor (or in some example, within a certain distance on the same floor) as the user 104, the wireless communication device 120 may generate a sound that is received by the wireless communication device 110 via a microphone (or vice-versa). The wireless communication device 110 may associate increasing amplitude of the received acoustic data with decreasing distance to the wireless communication device 120. In other example embodiments, the wireless communications device 120 (and/or the wireless communications device 110) may be programed to play an audible noise once the wireless communication device 110 is within a predefined distance during the finding operation. This may enable the user 102 to better locate the user 104. In a non-limiting example, a parent searching for a lost child may navigate to the floor that the child is located. When the wireless communication device of the parent is within a predefined distance of the child, the wireless communication device of the child may automatically emit a continuous and distinct audible sound that further assists the parent/finder in finding the child/findee.

In 330, the first wireless communication device 110 may output directions that enable a user of the first wireless communication device 110 to navigate to the second wireless communication device 120. In some example embodiments, the directions may be an arrow graphic displayed on the UI of an application running on the first wireless communication device 110. The directions may further include, but are not limited to, haptic feedback, audio-based directions, and text-based direction.

The directions may also be displayed in augmented reality with an augmented reality headset. For example, the arrow graphic may be incorporated into the field of view of the user 102. The augmented reality arrow may adapt to the field of view of the user as the user follows the arrow towards the findee. The augmented reality arrow may also adapt to obstacles along the travel path of the user 102. For example, the augmented reality arrow graphic may direct the user around an object that is obstructing the optimal (e.g., shortest distance route) navigational path based on vision inputs to the wireless communications device 110, such as the camera and LiDAR. This may enhance the user experience compared to directing the user 102 through an obstruction. In some example embodiments, the UI may augment the arrow graphic to incorporate a 3D coordinate system and may point the arrow along the Z-plane in addition the X and Y planes.

The directions may dynamically update based on the position of the finder and the findee. Therefore, the operations performed in 325-330 may be performed continuously until the findee is located or the user of the finder discontinues attempting to locate the findee.

In some example embodiments of FIG. 3, the ranging operations (e.g., UWB ranging) may be triggered by a discovery mechanism using Bluetooth including using Bluetooth advertisements. In other example embodiments, a discovery mechanism may be deployed over the Internet. The Internet-based discovery mechanism may be referred to herein as an Internet Discovery Service (IDS). In these example embodiments, a request may be sent from the finder device to the target device (or findee device) and, if the finder device receives a response from the target device, UWB ranging is triggered at the target device.

In still further example embodiments, a discovery mechanism may be deployed over a cellular connection. In these example embodiments, a request may be sent from the finder device to the target device (or findee device) using the cellular connection and, if the finder device receives a response from the target device, UWB ranging is triggered at the target device. Furthermore, other types of network connections may also be used to send/receive discovery messages to trigger the ranging operations.

In some example embodiments, the different types of discovery mechanisms (e.g., Bluetooth, IDS, cellular, etc.) may be used in combination. For example, two or more discovery mechanisms may be initiated in parallel and, if either of them is successful, the UWB ranging is triggered

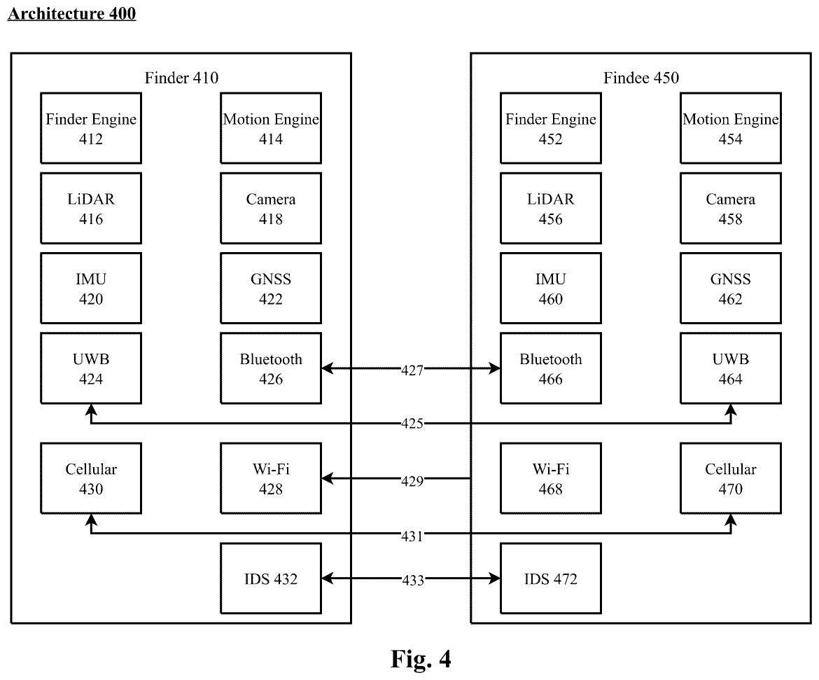

FIG. 4 shows an example architecture 400 for a finder 410 and findee 450 according to various example embodiments. The example architecture will be described with regard to the wireless communication device 200 of FIG. 2.

The architecture 400 provides a general example of the type of components that may interact with one another to enable a finder to locate a findee. The architecture 400 includes a finder 410 (e.g., wireless communication device 200) and the findee 450 (e.g., wireless communication device 120).

The finder 410 may include a finder engine 412, a motion engine 414, LiDAR 416, camera 418, IMU 420, global navigation satellite system (GNSS) 422, UWB 424, Bluetooth 426 Wi-Fi 428, Cellular 430 and IDS 432.

Wi-Fi 428 may represent hardware, software and/or firmware configured to communicate with an access point of a wireless local area network (WLAN). Information received from the WLAN or any other appropriate type of wireless network (e.g., cellular) may be used to determine a direction of the findee 450. However, the finder 410 does not require a network connection and may locate the findee 450 while offline. In some embodiments, information derived from a WLAN environment such as, but not limited to, WLAN or Wi-Fi access point names (APNs) may also be used to determine a direction of the findee 450. Other information exchanged over the link 429 may include a request/response used to trigger the ranging operations.

Cellular 430 may represent hardware, software and/or firmware configured to communicate with a cellular network. Information received from the cellular network may be used to determine a direction of the findee 450. However, the finder 410 does not require a cellular network connection and may locate the findee 450 while offline. In some embodiments, information derived from a cellular environment such as, but not limited to, cell identifications (IDs), may also be used to determine a direction of the findee 450. Other information exchanged over the link 431 may include a request/response used to trigger the ranging operations.

IDS 432 may represent hardware, software and/or firmware configured to perform communications over the Internet and perform the IDS discovery procedure described above. This may include exchanging discovery requests with the findee 450 over a link 433 as described above with regard to the method 300.

Bluetooth 426 may represent hardware, software and/or firmware configured to perform short-range communication with the findee 450. This may include exchanging advertisements with the findee 450 over a link 427 as described above with regard to the method 300.

UWB 424 may represent hardware, software and/or firmware configured to perform a ranging operation with the findee 450. This may include exchanging ranging data with the findee 450 over link 425. In some scenarios, the ranging operation may provide a more precise location of the findee 450.

GNSS 422 may represent hardware, software and/or firmware configured to receive positioning information collected by satellites. The positioning information may correspond to the finder 410 and/or findee 450 and may be used to determine a direction of the findee 450. The information collected by the Wi-Fi 428, Cellular 430 IDS 432, Bluetooth 426, UWB 424 and GNSS 422 may be provided to the motion engine 414.

The LiDAR 416 may represent hardware, software and/or firmware configured to collect information about the surroundings and environment of the finder 410. Camera 418 may also represent hardware, software and/or firmware configured to collect information about the surroundings and environment of the finder 410. Data collected using LiDAR and/or cameras may be used for three-dimensional mapping of a physical environment.

The IMU 420 may represent hardware, software and/or firmware configured to collect information about the motion of the finder 410. The IMU 420 may collect data such as, but not limited to, acceleration measurements of the finder 410 and angular velocity measurements of the finder 410.

The information collected by the LiDAR 416, the camera 418 and the IMU 420 may also be provided to the motion engine 414. The motion engine 414 may perform various operations related to deriving location information for the finder 410 and the findee 450. This may include performing position estimates of the finder 410 and/or the findee 450, performing a ranging estimate between the finder 410 and the findee 450, performing time of flight measurements on signals exchanged with the findee 450 and performing 3D mapping. In some examples, the motion engine 414 may use synthetic aperture techniques to derive location information for the finder 410 and/or findee 450. In some examples, the motion engine 414 may use machine learning techniques to derive location information for the finder 410 and/or the findee 450.

The finder engine 412 may manage operations related to interacting with the user (e.g., receiving user input via a UI, etc.). In addition, the finder engine 412 may manage operations related to outputting directions to the user, e.g., directional arrow pointing towards the findee 450, haptic feedback directing the user to the findee 450, text-based feedback directing the user to the findee 450, etc.

The findee 450 may include a findee engine 452, a motion engine 454, LiDAR 456, camera 458, IMU 460, global navigation satellite system (GNSS) 462, UWB 464, Bluetooth 466, Wi-Fi 468, Cellular 470 and IDS 472.

Wi-Fi 468 may represent hardware, software and/or firmware configured to communicate with an access point of a WLAN. However, the findee 450 does not require a network connection and may be located while offline.

Cellular 470 may represent hardware, software, and/or firmware configured to communicate with a cell or node of a cellular network, such as a 5G network. However, the example embodiments may also be implemented in other types of networks, including but not limited to LTE networks, future evolutions of the cellular protocol, or any other type of network.

Bluetooth 466 may represent hardware, software and/or firmware configured to perform short-range communication with the finder 410. This may include exchanging advertisements with the finder 410 over link 427 as described above with regard to the method 300.

UWB 464 may represent hardware, software and/or firmware configured to perform a ranging operation with the finder 410. This may include exchanging ranging data with the finder 410 over the link 425. In some scenarios, the ranging operation may provide a more precise location of the finder 410.

GNSS 462 may represent hardware, software and/or firmware configured to receive positioning information collected by satellites. The positioning information may correspond to the finder 410 and/or the findee 450. The information collected by the GNSS 462 may be provided to the finder 410 over the Bluetooth link 427, the UWB link 425 or in any other appropriate manner. The information collected by the Wi-Fi 468, the Cellular 470, the IDS 472, the Bluetooth 466, the UWB 464 and the GNSS 462 may be provided to the motion engine 454.

The LiDAR 456 may represent hardware, software and/or firmware configured to collect information about the surroundings and environment of the findee 450. The camera 458 may also represent hardware, software and/or firmware configured to collect information about the surroundings and environment of the findee 450. Data collected using LiDAR and/or cameras may be used for three-dimensional mapping of a physical environment. The information collected by the LiDAR 456 and the camera 458 may be provided to the finder 410 over the Bluetooth link 427, the UWB link 429 or in any other appropriate manner.

The IMU 460 may represent hardware, software and/or firmware configured to collect information about the motion of the findee 460. The IMU 460 may collect data such as, but not limited to, acceleration measurements of the findee 450 and angular velocity measurements of the findee 450. The information collected by the IMU 460 may be provided to the finder 410 over the Bluetooth link 427, the UWB link 429 or in any other appropriate manner.

The motion engine 454 may perform various operations related to deriving location information for the findee 450. This may include performing position estimates of the finder 410 and/or findee 450, performing a ranging estimate between the finder 410 and findee 450, performing time of flight measurements on signals exchanged with the finder 410 and performing 3D mapping. In some examples, the motion engine 454 may use synthetic aperture techniques to derive location information for the finder 410 and/or findee 450. In some examples, the motion engine 454 may use machine learning techniques to derive location information for the finder 410 and/or findee 450. The information derived by the motion engine 454 may be provided to the finder 410 over the Bluetooth link 427, the UWB link 429 or in any other appropriate manner.

The findee engine 452 may manage operations related to interacting with the user (e.g., receiving user input via a UI, generating output, etc.). In some embodiments, there may be a reciprocal relationship between wireless communication devices and each device may be a finder and a findee.

Example embodiments may be used to generate an accurate arrow at the finder. In some embodiments, the finder may generate an arrow based on core location information, odometry data and/or global positioning information. Core location information may include a combination camera data (images, video, etc.), IMU data, VIO and APNs.

According to some aspects, the example embodiments introduce techniques for generating directions that enable a finder to locate a findee. In the examples provided below, the directions are described with regard to an arrow that is displayed on a UI of the finder. The arrow is configured to dynamically update based on the motion of the finder and/or findee.

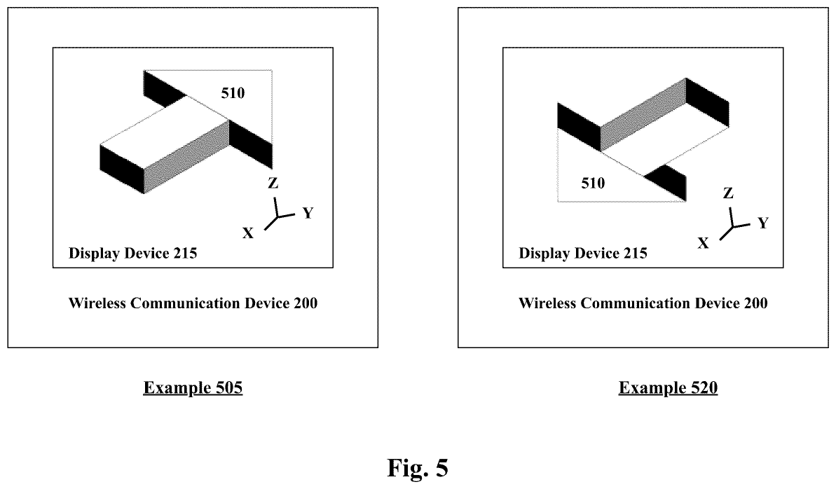

FIG. 5 shows example display devices showing navigational arrows, according to various example embodiments. Examples of an arrow directing the finder to the findee according to various example embodiments is shown in FIG. 5. Example 505 shows a display device 215 of the communication device 200 at a first time. The communication device 200 is operating as a finder and its display device 215 shows a graphic of an arrow 510. The arrow 510 is configured to point in the direction of the findee relative to the location of the finder. This allows the user to walk towards the findee (or move towards the findee in any other manner). In some examples, the graphic (e.g., arrow 510) may be a 2D graphic. In other examples, the graphic (e.g., arrow) may be a three-dimensional object and/or enhanced with additional graphics that provide further direction information that enables the user to navigate to the findee. For example, an additional graphic may indicate that the findee is on a certain floor.

Example 520 shows a display device 215 of the communication device 200 at a second time that is subsequent to the first time. In between the first time of example 505 and the second time of example 520, at least one of the finder or the findee has moved. As a result, the arrow 510 has moved so that it is still pointing in the direction of the findee relative to the location of the finder. The examples shown in FIG. 5 are provided as a general example of the type of information that may be provided to the user to enable the user to navigate towards the findee. While the example embodiments are described with regard to arrow generation, the example techniques introduced herein may be used to generate any appropriate type of output (e.g., haptic feedback, static graphics, dynamic graphics, audio alerts, text alerts, lights, etc.) that is configured to enable a finder to locate a findee in a physical environment.

### Examples

In a first example, a method, comprising generating, for transmission to a wireless communication device, a request to initiate a ranging operation, processing, based on one or more signals received from the wireless communication device, a response indicating that an apparatus is to locate the wireless communication device, generating, for transmission to a wireless communication device, first ranging data, processing, based on one or more signals received from the wireless communication device, second ranging data, determining a direction of the wireless communication device relative to the apparatus based on at least the first ranging data and the second ranging data, wherein the direction is based on a spherical coordinate system including a radial distance, an azimuthal angle, and a polar angle and generating, for display on a display device, a graphic based on at least the determined direction of the wireless communication device relative to the apparatus, the graphic indicating a three dimensional direction of the wireless communication device relative to the apparatus.

In a second example, the method of the first example, wherein determination of the direction of the wireless communication device relative to the apparatus is based on processing, a first barometric pressure based on a barometer reading, wherein the first barometric pressure corresponds with a first elevation of a navigational environment, processing, based on one or more signals received from the wireless communication device, a second barometric pressure corresponding to a second elevation of the navigational environment and determining a barometric pressure differential between the first barometric pressure and the second barometric pressure.

In a third example, the method of the first example, wherein determination of the direction of the wireless communication device relative to the apparatus is based on processing inertial measurement unit (IMU) data related to the apparatus and processing, based on one or more signals received from the wireless communication device, IMU data of the wireless communication device, wherein determination of the direction of the wireless communication device relative to the apparatus is based at least on the IMU related to the apparatus and the wireless communication device.

In a fourth example, the method of the first example, wherein the first and the second ranging data are exchanged by at least one of (i) ultra-wideband (UWB), (ii) a wireless local area network (WLAN), or (iii) a cellular network.

In a fifth example, the method of the first example, wherein the generated graphic is based on the spherical coordinate system.

In a sixth example, the method of the first example, wherein the generated graphic indicates that the apparatus and the wireless device are at different elevations of a navigational environment.

In a seventh example, the method of the first example, wherein the first ranging data is based on at least one of collected camera data, collected ultra-wideband data, or collected light detection and ranging (LiDAR) data.

In an eighth example, the method of the seventh example, further comprising, when the first ranging data is based on collected camera data or collected LiDAR data, adjusting the displayed graphic based on collected camera data or collected LiDAR data indicating an obstruction.

In a ninth example, the method of the first example, wherein determination of the direction of the wireless communication device relative to the apparatus is based at least on global navigation satellite system data related to the apparatus or the wireless communication device.

In a tenth example, the method of the first example, wherein generating the graphic to be displayed on the display device is further based on access point names (APNs) identified by at least one of the apparatus or the wireless communication device

In an eleventh example, the method of the first example, wherein the generated graphic comprises an arrow.

In a twelfth example, the method of the first example, wherein the request is transmitted via a short-rage connection, a Wi-Fi connection, an Internet connection or a cellular connection.

In a thirteenth example, a processor configured to perform any of the methods of the first through twelfth examples.

In a fourteenth example, a wireless communication device configured to perform any of the methods of the first through twelfth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a wireless communication device, a request to initiate a ranging operation;
process, based on one or more signals received from the wireless communication device, a response indicating that the apparatus is to locate the wireless communication device;
generate, for transmission to a wireless communication device, first ranging data;
process, based on one or more signals received from the wireless communication device, second ranging data;
determine a direction of the wireless communication device relative to the apparatus based on at least the first ranging data and the second ranging data, wherein the direction is based on a spherical coordinate system including a radial distance, an azimuthal angle, and a polar angle; and
generate, for display on a display device, a graphic based on at least the determined direction of the wireless communication device relative to the apparatus, the graphic indicating a three dimensional direction of the wireless communication device relative to the apparatus.

2. The apparatus of claim 1, wherein determination of the direction of the wireless communication device relative to the apparatus is based on the processing circuitry being configured to:
process, a first barometric pressure based on a barometer reading, wherein the first barometric pressure corresponds with a first elevation of a navigational environment;
process, based on one or more signals received from the wireless communication device, a second barometric pressure corresponding to a second elevation of the navigational environment; and
determine a barometric pressure differential between the first barometric pressure and the second barometric pressure.

3. The apparatus of claim 1, wherein determination of the direction of the wireless communication device relative to the apparatus is based on the processing circuitry being configured to:
process inertial measurement unit (IMU) data related to the apparatus; and
process, based on one or more signals received from the wireless communication device, IMU data of the wireless communication device,
wherein determination of the direction of the wireless communication device relative to the apparatus is based at least on the IMU related to the apparatus and the wireless communication device.

4. The apparatus of claim 1, wherein the first and the second ranging data are exchanged by at least one of (i) ultra-wideband (UWB), (ii) a wireless local area network (WLAN), or (iii) a cellular network.

5. The apparatus of claim 1, wherein the generated graphic is based on the spherical coordinate system.

6. The apparatus of claim 1, wherein the generated graphic indicates that the apparatus and the wireless device are at different elevations of a navigational environment.

7. The apparatus of claim 1, wherein the first ranging data is based on at least one of collected camera data, collected ultra-wideband data, or collected light detection and ranging (LiDAR) data.

8. The apparatus of claim 7, wherein the processing circuitry is further configured to:
when the first ranging data is based on collected camera data or collected LiDAR data, adjust the displayed graphic based on collected camera data or collected LiDAR data indicating an obstruction.

9. The apparatus of claim 1, wherein determination of the direction of the wireless communication device relative to the apparatus is based at least on global navigation satellite system data related to the apparatus or the wireless communication device.

10. The apparatus of claim 1, wherein generating the graphic to be displayed on the display device is further based on access point names (APNs) identified by at least one of the apparatus or the wireless communication device.

11. The apparatus of claim 1, wherein the generated graphic comprises an arrow.

12. The apparatus of claim 1, wherein the request is transmitted via a short-rage connection, a Wi-Fi connection, an Internet connection or a cellular connection.

13. A method performed by an apparatus, comprising:
generating, for transmission to a wireless communication device, a request to initiate a ranging operation;
processing, based on one or more signals received from the wireless communication device, a response indicating that the apparatus is to locate the wireless communication device;
generating, for transmission to a wireless communication device, first ranging data;
processing, based on one or more signals received from the wireless communication device, second ranging data;
determining a direction of the wireless communication device relative to the apparatus based on at least the first ranging data and the second ranging data, wherein the direction is based on a spherical coordinate system including a radial distance, an azimuthal angle, and a polar angle; and
generating, for display on a display device, a graphic based on at least the determined direction of the wireless communication device relative to the apparatus, the graphic indicating a three dimensional direction of the wireless communication device relative to the apparatus.

14. The method of claim 13, wherein determination of the direction of the wireless communication device relative to the apparatus is based on:
processing, a first barometric pressure based on a barometer reading, wherein the first barometric pressure corresponds with a first elevation of a navigational environment;
processing, based on one or more signals received from the wireless communication device, a second barometric pressure corresponding to a second elevation of the navigational environment; and
determining a barometric pressure differential between the first barometric pressure and the second barometric pressure.

15. The method of claim 13, wherein determination of the direction of the wireless communication device relative to the apparatus is based on:
processing inertial measurement unit (IMU) data related to the apparatus; and
processing, based on one or more signals received from the wireless communication device, IMU data of the wireless communication device,
wherein determination of the direction of the wireless communication device relative to the apparatus is based at least on the IMU related to the apparatus and the wireless communication device.

16. The method of claim 13, wherein the first and the second ranging data are exchanged by at least one of (i) ultra-wideband (UWB), (ii) a wireless local area network (WLAN), or (iii) a cellular network.

17. The method of claim 13, wherein the generated graphic is based on the spherical coordinate system.

18. The method of claim 13, wherein the generated graphic indicates that the apparatus and the wireless device are at different elevations of a navigational environment.

19. The method of claim 13, wherein the first ranging data is based on at least one of collected camera data, collected ultra-wideband data, or collected light detection and ranging (LiDAR) data.

20. The method of claim 19, further comprising:
when the first ranging data is based on collected camera data or collected LiDAR data, adjusting the displayed graphic based on collected camera data or collected LiDAR data indicating an obstruction.
